(19) United States
(12) Patent Application Publication
(10) Pub. No.: US 2013/0025297 A1
(43) Pub. Date: Jan. 31, 2013

(54) ROTARY VALVE AND CRYOGENIC REFRIGERATOR USING SAME

(71) Applicants: Takahiro MATSUBARA, Tokyo (JP); Youichirou Ikeya, Tokyo (JP)

(72) Inventors: Takahiro MATSUBARA, Tokyo (JP); Youichirou Ikeya, Tokyo (JP)

(73) Assignee: SUMITOMO HEAVY INDUSTRIES, LTD, Tokyo (JP)

(21) Appl. No.: 13/649,300

(22) Filed: Oct. 11, 2012

Related U.S. Application Data
(63) Continuation of application No. PCT/JP2011/059053, filed on Apr. 12, 2011.

(30) Foreign Application Priority Data
Apr. 19, 2010 (JP) 2010-095921

(51) Int. Cl. F16K 5/20; F25B 9/00

(52) U.S. Cl. 62/6; 251/304

(57) ABSTRACT

A rotary valve includes a valve body and a valve plate. The valve body has a body-side passage formed therein, and includes a first slide surface. The valve plate has a plate-side passage formed therein, and includes a valve plate body and a resin valve slide body. The valve plate body is formed of a non-magnetic material and includes an accommodation room. The resin valve slide body is accommodated in the accommodation room of the valve plate body. The resin valve slide body includes a second slide surface in close contact with the first slide surface of the valve body. The valve plate rotates to switch a state of connection of the body-side passage and the plate-side passage.

### CROSS-REFERENCE TO RELATED APPLICATIONS

This application is a continuation application filed under 35 U.S.C. 111(a) claiming benefit under 35 U.S.C. 120 and 365(c) of International Application PCT/JP2011/059053, filed on Apr. 12, 2011, designating the U.S., which claims priority to Japanese Patent Application No. 2010-095921, filed on Apr. 19, 2010. The entire contents of the foregoing applications are incorporated herein by reference.

### BACKGROUND OF THE INVENTION

1. Field of the Invention

The present invention relates generally to rotary valves and cryogenic refrigerators using the same, and more particularly to a rotary valve that switches a passage by rotating a valve plate held in contact with a valve body and to a cryogenic refrigerator using the same.

2. Description of the Related Art

In general, in Gifford-McMahon (GM) refrigerators using a rotary valve system, the airtightness of a refrigerant gas is provided and the switching of a valve is performed by pressing two disks, one serving as a stator and the other serving as a rotor, against each other and rotating the rotor. (See, for example, Japanese Laid-Open Patent Application No. 2007-205581.)

FIG. 1 is a diagram illustrating a rotary valve 100 used in the conventional GM refrigerator. The conventional rotary valve 100 includes a valve body 101 (a stator) having a slide surface 101a and a valve plate 102 (a rotor) having a slide surface 102a. A first gas passage 104 and a second gas passage 105 are formed in the valve body 101. A groove part 106 and a gas passage 107 are formed in the valve plate 102.

The valve plate 102 is rotatably supported by a rolling bearing 103, and is caused to rotate by a rotating mechanism (not graphically illustrated). The valve body 101 is not rotatable, and is pressed against the valve plate 102. The valve body 101 is pressed against the valve plate 102, so that the slide surfaces 101a and 102a come into sliding contact with each other in an airtight manner.

The first and second gas passages 104 and 105 have respective open ends at the slide surface 101a. The gas passage 107 has an open end at the slide surface 102a. The groove 106 is open at the slide surface 102a. Accordingly, switching may be performed between a state where the second gas passage 105 communicates with the gas passage 107 and a state where the second gas passage 105 communicates with the first gas passage 104 via the groove part 106 by the rotation of the valve plate 102.

The GM refrigerator is often used in magnetic fields such as magnetic resonance imaging (MRI) systems, and there is a problem in that the movement of a magnetic structure in a magnetic field disturbs the magnetic field. Therefore, in the conventional rotary valve 100, a non-magnetic material such as aluminum is used for the valve plate 102, which is a rotating part, and a high-performance resin is used for the valve body 101, which is a stationary part. Further, in order to protect the slide surface 102a of the valve plate 102 that comes into sliding contact with the valve body 101, a surface treatment layer 108 is formed by hard-anodizing the entire aluminum surface, and this surface treatment layer 108 is subjected to surface polishing.

### SUMMARY OF THE INVENTION

According to an aspect of the present invention, a rotary valve includes a valve body having a body-side passage formed therein, the valve body including a first slide surface; and a valve plate having a plate-side passage formed therein, the valve plate including a valve plate body formed of a non-magnetic material, the valve plate body including an accommodation room; a resin valve slide body accommodated in the accommodation room of the valve plate body, the resin valve slide body including a second slide surface in close contact with the first slide surface of the valve body, wherein the valve plate rotates to switch a state of connection of the body-side passage and the plate-side passage.

According to an aspect of the present invention, a cryogenic refrigerator including a gas compressor configured to compress a refrigerant gas taken in from an inlet port and to discharge the compressed refrigerant gas from an outlet port; a cylinder configured to be fed with the refrigerant gas; a displacer configured to reciprocate in the cylinder to expand the compressed refrigerant gas in the cylinder; a drive unit configured to cause the displacer to reciprocate in the cylinder; and a rotary valve, the rotary valve including a valve body having a first body-side passage and a second body-side passage formed therein, the first body-side passage being connected to the outlet port and the second body-side passage being connected to the cylinder, the valve body including a first slide surface; and a valve plate having a plate-side passage formed therein, the plate-side passage being connected to the inlet port, the valve plate including a valve plate body formed of a non-magnetic material, the valve plate body including an accommodation room; a resin valve slide body accommodated in the accommodation room of the valve plate body, the resin valve slide body including a second slide surface in close contact with the first slide surface of the valve body, wherein the valve plate rotates to cause the second body-side passage to be connected selectively to one of the first body-side passage and the plate-side passage.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a cross-sectional view of a conventional rotary valve;

FIG. 2 is a cross-sectional view of a rotary valve and a cryogenic refrigerator using the rotary valve according to an embodiment of the present invention;

FIG. 3 is an exploded perspective view of the rotary valve according to the embodiment of the present invention;

FIG. 4 is a cross-sectional view of the disassembled rotary valve according to the embodiment of the present invention; and

FIG. 5 is a cross-sectional view of the assembled rotary valve according to the embodiment of the present invention.

### DETAILED DESCRIPTION OF THE PREFERRED EMBODIMENTS

According to the above-described conventional rotary valve 100, however, the surface treatment layer 108 is formed in the valve plate 102, and this surface treatment layer 108 is subjected to surface polishing. This complicates the manufacturing of the valve plate 102, thus causing the valve plate 102 to be extremely expensive. Further, at the time of periodic maintenance, both the valve body 101 and the valve plate 102 need to be replaced, thus causing the problem of a high cost of replacement parts for maintenance.

According to an aspect of the present invention, an improved useful rotary valve is provided that may solve one or more of the above-described problems of the conventional techniques, and a cryogenic refrigerator is provided that uses the rotary valve.

According to an aspect of the present invention, a rotary valve is provided that reduces its manufacturing cost, and a cryogenic refrigerator is provided that uses the rotary valve.

According to an aspect of the present invention, a valve plate includes a resin valve slide body having a plate-side slide surface; and a valve plate body in which an accommodation room that accommodates the valve slide body is formed. This eliminates the necessity of surface polishing on the plate-side slide surface, which is performed on the slide surface of the conventional valve plate. Accordingly, it is possible to reduce the cost of the rotary valve and the cryogenic refrigerator.

A description is given, with reference to the accompanying drawings, of embodiments of the present invention.

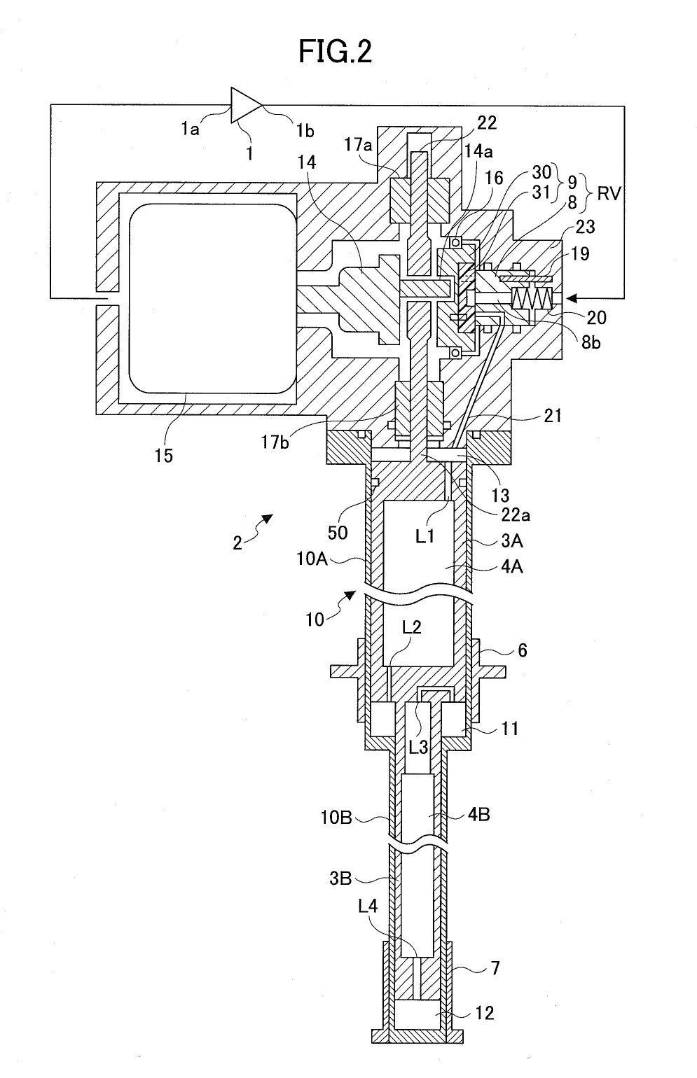

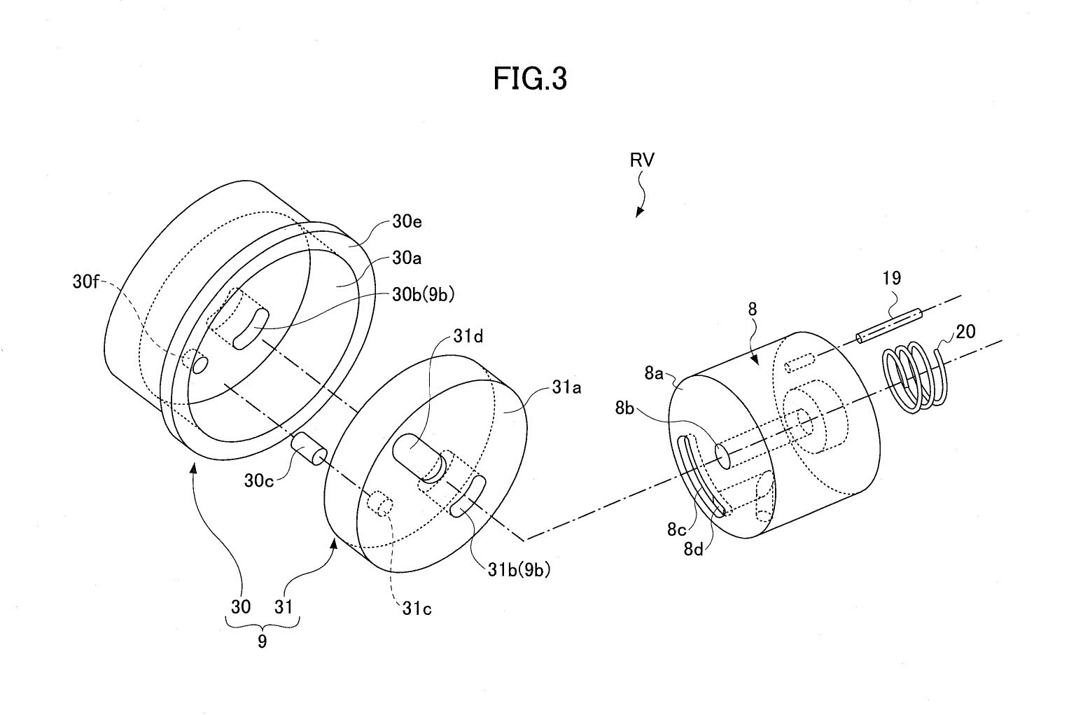

FIG. 2 is a cross-sectional view of a cryogenic refrigerator according to an embodiment of the present invention. FIG. 3 through FIG. 5 are diagrams for illustrating a rotary valve according to the embodiment. In this embodiment, a description is given taking a GM refrigerator as an example of the cryogenic refrigerator. Further, the GM refrigerator and the rotary valve according to this embodiment are assumed to be used in a magnetic field where the disturbance of the magnetic field is avoided as in the MRI system.

The GM refrigerator according to this embodiment includes a gas compressor 1 and a cold head 2. The cold head 2 includes a housing 23 and a cylinder part 10. The gas compressor 1 takes in a refrigerant gas from an inlet port 1a, compresses the refrigerant gas, and discharges a high-pressure refrigerant gas from an outlet port 1b. Helium gas is used as the refrigerant gas.

The cylinder part 10, which has a two-stage structure, includes a first-stage cylinder 10A and a second-stage cylinder 10B. The second-stage cylinder 10B is thinner than the first-stage cylinder 10A. A first-stage displacer 3A and a second-stage displacer 3B are so inserted in the first-stage cylinder 10A and the second-stage cylinder 10B as to be reciprocatable in the axial directions of the first-stage cylinder 10A and the second-stage cylinder 10B, respectively.

The first-stage displacer 3A and the second-stage displacer 3B are connected to each other by a joint mechanism (not graphically illustrated). A regenerator material 4A is provided inside the first-stage displacer 3A, and a regenerator material 4B is provided inside the second-stage displacer 3B. Further, gas passages L1, L2, L3, and L4 through which a refrigerant gas passes are formed in the first-stage displacer 3A and the second-stage displacer 3B.

A first-stage expansion chamber 11 and an upper chamber 13 are formed in a lower end portion on the second-stage cylinder 10B side and in an upper end portion on the other side, respectively, inside the first-stage cylinder 10A. Further, a second-stage expansion chamber 12 is formed in a lower end portion on the side opposite to the first-stage cylinder 10A side inside the second-stage cylinder 10B.

The upper chamber 13 and the first-stage expansion chamber 11 are connected via the gas passage L1, a first-stage regenerator material filling chamber filled with the regenerator material 4A, and the gas passage L2. The first-stage expansion chamber 11 and the second-stage expansion chamber 12 are connected via the gas passage L3, a second-stage regenerator material filling chamber filled with the regenerator material 4B, and the gas passage L4.

A cooling stage 6 is provided at a position substantially corresponding to the first-stage expansion chamber 11 on the exterior circumferential surface of the first-stage cylinder 10A. A cooling stage 7 is provided at a position substantially corresponding to the second-stage expansion chamber 12 on the exterior circumferential surface of the second-stage cylinder 10B.

A sealing member 50 is provided at a position near an upper chamber 13 side end on the exterior circumferential surface of the first-stage displacer 3A. The sealing member 50 seals the space between the exterior circumferential surface of the first-stage displacer 3A and the interior circumferential surface of the first-stage cylinder 10A.

The first-stage displacer 3A is connected via a connecting mechanism (not graphically illustrated) to an output shaft 22a of a Scotch yoke 22. The Scotch yoke 22 is so supported by a pair of sleeve bearings 17a and 17b fixed to the housing 23 as to be movable in the axial directions of the first-stage displacer 3A. In the sleeve bearing 17b, the airtightness of the sliding part is maintained, so that the space inside the housing 23 and the upper chamber 13 are partitioned in an airtight manner.

A motor 15 is connected to the Scotch yoke 22. The rotation of the motor 15 is converted into reciprocation by a crank 14 and the Scotch yoke 22. This reciprocation is transmitted to the first-stage displacer 3A via the output shaft 22a and the connecting mechanism. As a result, the first-stage displacer 3A reciprocates inside the first-stage cylinder 10A, and the second-stage displacer 3B reciprocates inside the second-stage cylinder 10B. According to this embodiment, the motor 15 and the Scotch yoke 22 (including the output shaft 22a) may form a drive unit.

When the first-stage displacer 3A and the second-stage displacer 3B move upward in FIG. 2, the volume of the upper chamber 13 decreases while the volumes of the first-stage expansion chamber 11 and the second-stage expansion chamber 12 increase. Meanwhile, when the first-stage displacer 3A and the second-stage displacer 3B move downward in FIG. 2, the volume of the upper chamber 13 increases while the volumes of the first-stage expansion chamber 11 and the second-stage expansion chamber 12 decrease. With these changes in the volumes of the upper chamber, the first-stage expansion chamber 11, and the second-stage expansion chamber 12, the refrigerant gas moves through the gas passages L1 through L4.

Further, when the refrigerant gas passes through the regenerator materials 4A and 4B that fill in the first-stage and second-stage displacers 3A and 3B, respectively, heat is exchanged between the refrigerant gas and the regenerator materials 4A and 4B. As a result, the regenerator materials 4A and 4B are cooled by the refrigerant gas.

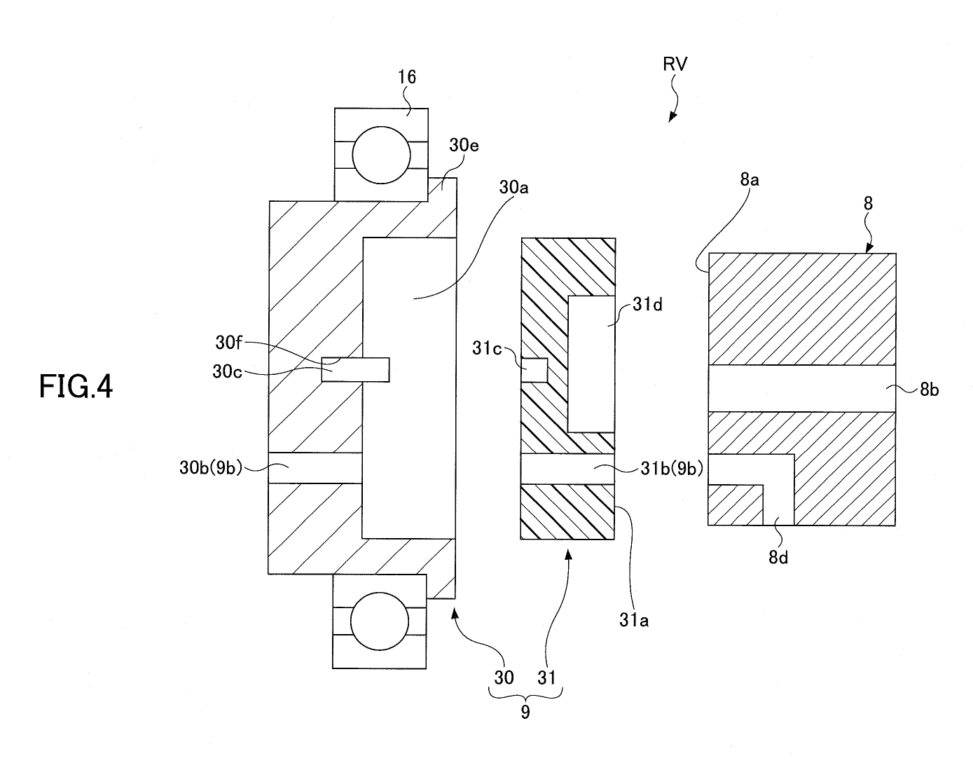

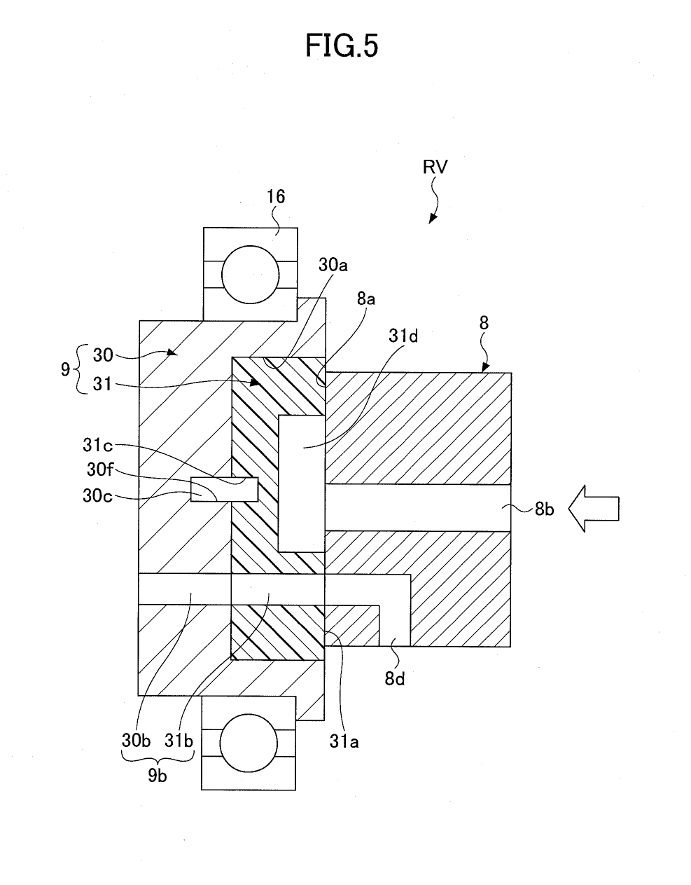

Next, a description is given, with reference to FIG. 3 through FIG. 5 as well as. FIG. 2, of a rotary valve RV. FIG. 3 is an exploded perspective view of the rotary valve RV. FIG. 4 is a cross-sectional view of the disassembled rotary valve RV. FIG. 5 is a cross-sectional view of the assembled rotary valve RV.

In the passage of the refrigerant gas, the rotary valve RV is provided between the upper chamber 13 and the inlet port 1a and the outlet port 1b of the gas compressor 1. The rotary valve RV operates to switch the passage of the refrigerant gas (from one to another). For example, the rotary valve RV switches a first mode in which the refrigerant gas discharged from the outlet port 1b of the gas compressor 1 is guided into the upper chamber 13 and a second mode in which the refrigerant gas inside the upper chamber 13 is guided to the inlet port 1a of the gas compressor 1.

The rotary valve RV includes a valve body 8 and a valve plate 9. The valve plate 9 includes a valve plate body 30 and a valve slide member 31 (a valve slide body) (of which a description is given in detail below).

The valve plate 9 is so supported by a rolling bearing 16 as to be rotatable inside the housing 23. An eccentric pin 14a of the crank 14, which drives the Scotch yoke 22, revolves around an axis of rotation, thereby causing the valve plate 9 to rotate. The valve body 8 is pressed against the valve plate 9 by a coil spring 20, and is locked (fixed) by a pin 19 so as not to rotate.

The coil spring 20 is a pressing part provided in order to press the valve body 8 so that the valve body 8 is prevented from being separated from the valve plate 9 when the discharge-side pressure becomes higher than the feed-side pressure. A force to press the valve body 8 against the valve plate 9 at the time of operation is generated by a pressure difference between the refrigerant gas feed side and the refrigerant gas discharge side acting on the valve body 8.

The valve body 8 has a columnar shape. The valve body 8 includes a flat slide surface 8a that faces the valve plate 9. The slide surface 8a comes into surface contact with a slide surface 31a of the valve slide member 31 of the valve plate 9.

A first gas passage 8b (a first body-side passage) penetrates through the valve body 8 along the central axis of the valve body 8. One end of the first gas passage 8b is open at the slide surface 8a. Further, the other end of the first gas passage 8b is connected to the outlet port 1b of the gas compressor 1 illustrated in FIG. 2.

Further, a groove 8c is formed along an arc (of a circle) having a center at the central axis of the valve body 8 on the slide surface 8a of the valve body 8. Further, a second gas passage 8d (a second body-side passage), having an inverted L-letter shape in a side view, is formed in the valve body 8. One end of the second gas passage 8d is open at the bottom surface of the groove 8c. The other end of the gas passage 8d is open at the exterior circumferential surface of the valve body 8. The end of the second gas passage 8d open at the exterior circumferential surface of the valve body 8 communicates with the upper chamber 13 via a gas passage 21 formed in the housing 23 as illustrated in FIG. 2.

A groove 31d is formed on the slide surface 31a of the valve plate 9 (the valve slide member 31) to extend radially from the center of the slide surface 9a. When the valve plate 9 rotates so that the peripheral-side end portion of the groove 31d overlaps (in part) with the groove 8c of the slide surface 8a of the valve body 8, the first gas passage 8b and the second gas passage 8d communicate with each other via the groove 31d.

A plate-side gas passage 9b (including gas passages 30b and 31b) extends parallel to the axis of rotation through the valve plate 9 (the valve plate body 30 and the valve slide member 31). One end of the plate-side gas passage 9b is open at the slide surface 31a. This end of the plate-side gas passage 9b is open at substantially the same radial position on the slide surface 31a as the groove 8c is formed on the slide surface 8a of the valve body 8.

Therefore, when the valve plate 9 rotates so that the opening (the end on the valve body 8 side) of the plate-side gas passage 9b overlaps (in part) with the groove 8c of the valve body 8, the second gas passage 8d and the plate-side gas passage 9b communicate with each other. The other end of the plate-side gas passage 9b communicates with the inlet port 1a of the gas compressor 1 via a hollow inside the housing 23 as illustrated in FIG. 2.

Therefore, when the first gas passage 8b and the second gas passage 8d communicate with each other via the groove 31d and the groove 8c, a refrigerant gas is fed from the gas compressor 1 into the upper chamber 13 via the rotary valve RV. When the second gas passage 8d and the plate-side gas passage 9b communicate with each other, the refrigerant gas inside the upper chamber 13 is collected into the gas compressor 1. Accordingly, by rotating the valve plate 9, the introduction (feeding) of a refrigerant gas into the upper chamber 13 and the collection (discharge) of a refrigerant gas from the upper chamber 13 are repeated.

Here, a description is given in more detail of the valve body 8 and the valve plate 9.

According to this embodiment, the valve body 8, which operates as a stator (a stationary part), is formed of a metal such as hardened steel. Even when the valve body 8 is formed of a metal that is such a magnetic material, the application of the rotary valve RV and the cryogenic refrigerator of this embodiment to MRI or the like does not cause the magnetic field of MRI to be disturbed by the cryogenic refrigerator or the rotary valve RV in the magnetic field because the valve body 8 does not rotate.

The material of the valve body 8 is not limited to magnetic materials, and may be a non-magnetic material such as aluminum having an anodized surface.

The valve plate 9 includes the valve plate body 30 and the valve slide member 31. The valve plate body 30 is formed of a non-magnetic material, for example, a non-magnetic metal material such as a non-magnetic stainless steel (for example, SUS304, SUS316, or SUS310S according to Japanese Industrial Standards). Examples of non-magnetic materials may also include fiber reinforced plastic (FRP) materials such as carbon fiber reinforced plastic and glass fiber reinforced plastic. The valve plate body 30 is rotatably supported in the housing 23 by the rolling bearing 16. Therefore, a flange part 30e that engages with the rolling bearing 16 is formed on the front side (the side facing toward the valve body 8) of the valve plate body 30.

Further, an accommodation room 30a for accommodating the valve slide member 31 is formed on the surface of the valve plate body 30 that faces toward the valve body 8. This accommodation room 30a has a depressed (recessed) shape, and a rotation stop pin 30c (which may form a rotation prevention member) is provided at the bottom of the accommodation room 30a.

This rotation stop pin 30c engages with a rotation stop recess 30f formed in the valve plate body 30 and a rotation stop recess 31c formed in the valve slide member 31 to prevent the rotation of the valve slide member 31 relative to the valve plate body 30. However, the rotation stop pin 30c does not completely fix the valve slide member 31 to the valve plate body 30, and serves to prevent the rotation of the valve slide member 31 relative to the valve plate body 30. Therefore, the valve slide member 31 is detachable from and reattachable to the valve plate body 30 (in the directions of the axis of rotation).

Further, the gas passage 30b, which forms part of the plate-side gas passage 9b, is formed in the valve plate body 30. This gas passage 30b is formed through the bottom plate part of the accommodation room 30a of the valve plate body 30. Therefore, one end of the gas passage 30b is open at the bottom surface of the accommodation room 30a, and the other end of the gas passage 30b communicates with the inlet port 1a of the gas compressor 1 via the hollow inside the housing 23 as described above.

The valve slide member 31 is formed of resin, and has a disk shape. Examples of resin used for the valve slide member 31 include tetrafluoroethylene (for example, BEAREE FL3000 manufactured by NTN Corporation). In the valve slide member 31, the above-described groove 31d is formed on the slide surface 31a that comes into close contact with the valve body 8. Further, the gas passage 31b, which forms part of the plate-side gas passage 9b, is formed through the valve slide member 31. The gas passage 31b communicates with the gas passage 30b formed in the valve plate body 30 to form the plate-side gas passage 9b when the valve slide member 31 is attached to the accommodating room 30a of the valve plate body 30.

Accordingly, when the valve plate body 30 is caused to rotate by the drive unit with the valve slide member 31 attached to the valve plate body 30, the valve slide member 31, which is attached to the valve plate body 30 with the rotation stop pin 30c preventing the rotation of the valve slide member 31, also starts to rotate. When the valve plate 9 (the valve plate body 30 and the valve slide member 31) thus rotates relative to the valve body 8, switching is performed between a state in which the first gas passage 8b and the second gas passage 8d are connected by the groove 31d (and the groove 8c) and a state in which the second gas passage 8d is connected to the plate-side gas passage 9b of the valve plate 9 as described above.

At this point, the valve plate body 30 is formed of a non-magnetic material such as a non-magnetic stainless steel and the valve slide member 31 is formed of resin, which is also non-magnetic. Therefore, even when the cryogenic refrigerator and the rotary valve RV according to this embodiment are used in an environment where changes in a magnetic field are avoided, the magnetic field is not disturbed by the rotation of the valve plate body 30 and the valve slide member 31.

Further, according to this embodiment, the slide surface 31a of the valve plate 9 is formed (defined) on the resin valve slide member 31. This makes it possible to eliminate the necessity of anodizing, which is performed in the conventional aluminum valve plate 102, thus making it possible to reduce the cost of the valve plate 9.

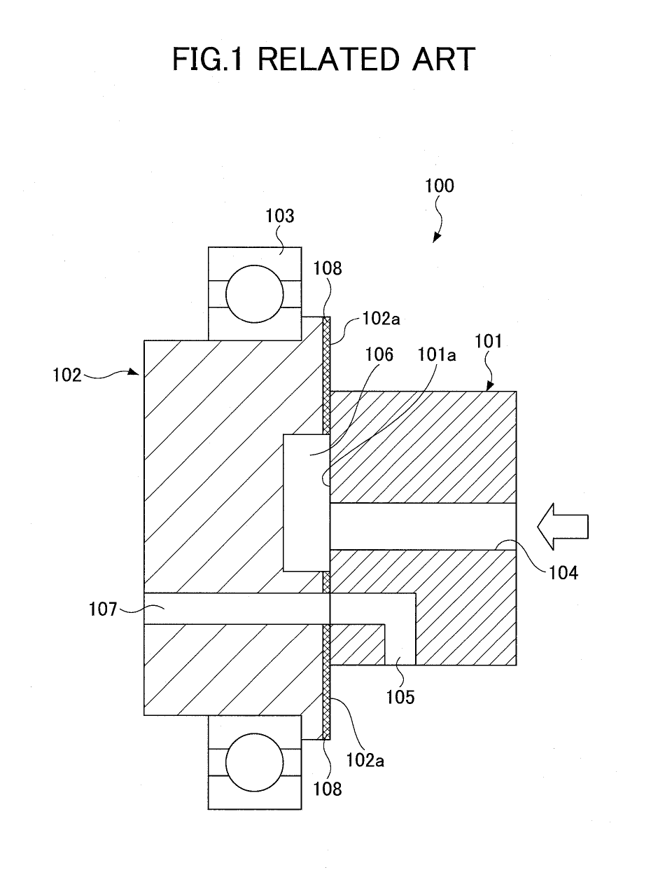

Further, in the case of performing maintenance of the conventional rotary valve 100 (FIG. 1), both the valve body 101 and the valve plate 102 are replaced because both the slide surface 101a and the slide surface 102a are subject to wear. However, according to the rotary valve RV of this embodiment, no part of the valve plate body 30 is subject to wear, and the valve slide member 31 is detachable from and reattachable to the valve plate body 30. Therefore, maintenance may be performed by replacing the valve body 8 and the valve slide member 31.

The valve plate body 30, which has the accommodation room 30a, the gas passage 30b, and the rotation stop pin 30c provided in stainless steel, is more expensive than the valve slide member 31. Since the valve slide member 31 and the valve body 8, which are less expensive than the valve plate body 30, are replaced at the time of maintenance, it is also possible to reduce the cost of replacement parts at the time of maintenance.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A rotary valve, comprising:
a valve body having a body-side passage formed therein, the valve body including a first slide surface; and
a valve plate having a plate-side passage formed therein, the valve plate including
a valve plate body formed of a non-magnetic material, the valve plate body including an accommodation room;
a resin valve slide body accommodated in the accommodation room of the valve plate body, the resin valve slide body including a second slide surface in close contact with the first slide surface of the valve body, wherein the valve plate rotates to switch a state of connection of the body-side passage and the plate-side passage.

2. The rotary valve as claimed in claim 1, wherein the valve plate further comprises:
a rotation prevention member configured to prevent a rotation of the valve slide body relative to the valve plate body.

3. The rotary valve as claimed in claim 1, wherein the valve slide body is configured to be detached from and reattached to the valve plate body.

4. The rotary valve as claimed in claim 1, wherein the valve body is formed of a magnetic material.

5. A cryogenic refrigerator, comprising:
a gas compressor configured to compress a refrigerant gas taken in from an inlet port and to discharge the compressed refrigerant gas from an outlet port;
a cylinder configured to be fed with the refrigerant gas;
a displacer configured to reciprocate in the cylinder to expand the compressed refrigerant gas in the cylinder;
a drive unit configured to cause the displacer to reciprocate in the cylinder; and
a rotary valve,
the rotary valve including
a valve body having a first body-side passage and a second body-side passage formed therein, the first body-side passage being connected to the outlet port and the second body-side passage being connected to the cylinder, the valve body including a first slide surface; and
a valve plate having a plate-side passage formed therein, the plate-side passage being connected to the inlet port, the valve plate including
a valve plate body formed of a non-magnetic material, the valve plate body including an accommodation room;
a resin valve slide body accommodated in the accommodation room of the valve plate body, the resin valve slide body including a second slide surface in close contact with the first slide surface of the valve body, wherein the valve plate rotates to cause the second body-side passage to be connected selectively to one of the first body-side passage and the plate-side passage.
